(19) United States
(12) Patent Application Publication
(10) Pub. No.: US 2025/0046019 A1
(43) Pub. Date: Feb. 6, 2025

(54) AUGMENTED REALITY OBJECT BEHAVIOR VISUALIZATION

(71) Applicant: International Business Machines Corporation, Armonk, NY (US)

(72) Inventors: Sarbajit K. Rakshit, Kolkata (IN); Manikandan Padmanaban, Chennai (IN); Jagabondhu Hazra, BANGALORE (IN)

(73) Assignee: International Business Machines Corporation, Armonk, NY (US)

(21) Appl. No.: 18/230,470

(22) Filed: Aug. 4, 2023

(51) Int. Cl. G06T 19/00; G06V 20/20; G08G 1/16

(52) U.S. Cl. CPC G06T 19/006; G06V 20/20; G08G 1/166; G06V 2201/07

(57) ABSTRACT

An embodiment establishes an object behavior database, wherein the object behavior database comprises historical object behavior data corresponding to one or more objects. The embodiment scans a surrounding environment for one or more objects. The embodiment detects an object in the surrounding environment. The embodiment retrieves historical object behavior data corresponding to the object detected in the surrounding environment. The embodiment generates media corresponding to the object based in part on the historical behavior data and a current contextual scenario. The embodiment displays the media on a display interface.

### BACKGROUND

The present invention relates generally to augmented reality. More particularly, the present invention relates to a method, system, and computer program for augmented reality based object detection and behavior visualization.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

Augmented reality (AR) technology integrates digital information with a user's physical environment in real time. Unlike virtual reality (VR), which creates a wholly artificial digital environment, AR technology enables a user to experience a real-world environment with generated perceptual information overlaid on top of the real world environment, by combining digital and three-dimensional (3D) components with an individual's perception of the real world, to create an interwoven experience where digital information may alter and/or enhance the user's perception of the real world. Further, AR technology may be configured to provide visual elements, sound and/or other sensory information to a user through a display device, such as smartphone, headset display device, vehicle windshield integrated with AR glass, etc. AR technology has a variety of applications, including but not limited to, providing additional information related to objects existing in a surrounding environment, improving decision making capability within a physical environment, developing systems for enhanced hazard detection, entertainment, as well as other applications.

### SUMMARY

The illustrative embodiments provide for object detection and behavior visualization. An embodiment includes establishing an object behavior database, wherein the object behavior database comprises historical object behavior data corresponding to one or more objects. The embodiment also includes scanning a surrounding environment for one or more objects. The embodiment also includes detecting an object in the surrounding environment. The embodiment also includes retrieving historical object behavior data corresponding to the object detected in the surrounding environment. The embodiment also includes generating media corresponding to the object based in part on the historical object behavior data and a current contextual scenario. The embodiment also includes displaying the media on a display interface. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2A depicts a block diagram of a computing infrastructure in accordance with an illustrative embodiment;

FIG. 2B depicts a block diagram of an example an evaluator module in accordance with an illustrative embodiment;

FIG. 2C depicts a block diagram of an example processing environment corresponding to a vehicle safety system in accordance with an illustrative embodiment;

FIG. 2D depicts a diagram of an example vehicle equipped with an object detector system in accordance with an illustrative embodiment;

FIG. 2E depicts a diagram of an example vehicle communication system in accordance with an illustrative embodiment;

FIG. 3A depicts an example operating environment in accordance with an illustrative embodiment;

FIG. 3B depicts an example operating environment in accordance with an illustrative embodiment;

FIG. 3C depicts an interior cabin view of an example vehicle equipped with an objection detection system in accordance with an illustrative embodiment;

FIG. 4 depicts a block diagram of an example system for object detection and behavior visualization in accordance with an illustrative embodiment;

FIG. 5 depicts block diagram of an abstracted model of an example processing environment for training a machine learning model to identify an object in a surrounding environment in accordance with an illustrative embodiment;

FIG. 6 depicts a block diagram of an abstracted model of an example process of constructing an object-behavior mapping in accordance with an illustrative embodiment; and

FIG. 7 depicts a flowchart of an example process for object detection and behavior visualization in accordance with an illustrative embodiment.

### DETAILED DESCRIPTION

Drivers of vehicles need to be cautious of their surrounding. Every year, there are millions of vehicle related accidents throughout the world. Many of these accidents may be avoided, thus preventing damage to vehicles and property, as well as preventing injury to persons and/or even death.

Drivers of vehicles traditionally rely on their own senses when operating a vehicle. The sense of sight is perhaps the most relied upon sense for an operator of a vehicle. However, sight varies from driver to driver, and not all drivers may be able to see the same points of concern while operating a vehicle. Further, the human sensory perception and the human mind alone may be limited when it comes to perceiving all of the visual and other sensory information existing in a surrounding environment, that may be useful to detecting potential points of concern while driving.

Autonomous vehicle technology has evolved to provide vehicles that are capable of driving autonomously. Autonomous vehicles today may capable of many tasks related to self-driving through the use of multiple co-working systems. Autonomous vehicles may be able to create and maintain a map of their surroundings based on a variety of sensors situated in different parts of the vehicle. Radar sensors may be configured monitor the position of nearby vehicles. Video cameras may be configured detect traffic lights, read road signs, track other vehicles, and recognize pedestrians. Further, advancements in augmented reality (AR) technology have become incorporated into the automotive industry. For example, AR technology has began to become integrated into vehicle windshields, enabling virtual elements to be overlaid on top of real surrounding outside of a vehicle, which may provide drivers and/or passengers with additional information regarding the surrounding environment of the vehicle.

However, despite improvements in autonomous vehicle technology, there still may be instances where it may be preferable for a driver of a vehicle to manually operate the vehicle. For example, depending on the circumstance, an autonomous vehicle may be unable to perform certain driving related tasks outside certain parameters or in certain situations. Also, there may be instances where a human operator may simply prefer to manually drive a vehicle.

Despite the advancements in autonomous vehicle technology and AR technology, currently there is no way to anticipate the behavior of objects detected in a surrounding environment. These current limitations make it impossible for drivers of vehicles to be fully aware of the potential points of concern and/or hazardous situations that may exist while driving. As a result, current object detection applications are insufficient and ineffective in providing comprehensive awareness of potential points of concern and/or hazardous situations that may present while driving.

While a vehicle is being driven manually, a driver needs to understand as well as anticipate the behavior of objects present on the road. However, it is contemplated that in some situations, some of the objects and/or the contextual scenario may not be visible and/or understandable by a driver. In those situations, a driver would benefit from a system and/or method that enables the driver to visualize the anticipated behavior of one or more objects that present one or more potentials points of concern in the surrounding environment in advance, so that the driver can understand what action need to be taken during driving to prevent any potential consequences that may be resultant from the point of concern objects. Further, even in situations where a vehicle is not being manually operated, the driver and/or passenger may still want or need to understand why certain responsive actions may be taken by a vehicle in response to detecting an object presenting a potentially hazardous situation. For example, if an autonomous vehicle suddenly alters a driving pattern (e.g., changing a lane, applying a break, etc.) in response to a predicted accidental scenario, a passenger might not be able to understand why the vehicle suddenly changed its driving pattern. Accordingly, a passenger may benefit from an visualization depicting and/or why the vehicle changed its driving parameter suddenly.

The present disclosure addresses the deficiencies described above by providing a process (as well as a system, method, machine-readable medium, etc.) that develops an object detection and behavior visualization system that considers historical object behavior and an object detection algorithm that leverages sensor data obtained via a sensor system. Disclosed embodiments combine machine learning techniques with reinforcement learning to detect one or more objects in a surrounding environment, anticipate expected object behavior of the one or more objects, identify one or more point of concern objects based on the expected behavior corresponding to the one more objects, and generate media to display on an augmented reality display interface representative of expected object behavior of point of concern objects, potential consequences associated with the object based in part on the expected objected behavior, and/or one or more alterations to a driving to a driving pattern to be undertaken to avoid potential consequences, in order to alert a driver and/or passenger of an alteration to driving pattern that may be necessary to prevent a potential consequence.

As used throughout the present disclosure, the term “machine learning model” (or simply “ML model”) refers to a computer program configured to find patterns, makes decisions, classify data and/or generate new data based on a previously unseen dataset. As a nonlimiting example, in the context of image recognition, an ML model can be configured to recognize objects in image data. An ML model may perform such tasks by having the model trained with a particular dataset, referred to as a training dataset. The training dataset may include labeled data and/or unlabeled data. Labeled data refers to a dataset of data samples that have been labeled with a particular attribute. As a nonlimiting example, labeled data of images may include images wherein each image has been labeled as a cat, dog, bird, fish, etc. Unlabeled data refers to a dataset of data samples that have not been labeled with any particular attribute. To continue on the previous nonlimiting example, unlabeled data of images may contain objects, however the types of objects within the data samples are not known. During training of an ML model, one or more machine learning algorithms may be optimized to find certain patterns or outputs from the training dataset, depending on the desired task being performed. Further, the ML model may include or one or neural networks, including but not limited to, a neural network, a deep neural network (DNN), a convolution neural network (CNN), a recurrent neural network (RNN), a generative adversarial network (GAN), a transformer network, as well as other neural networks architectures, and/or any combination thereof. The output of the training process results in a computer program with specific rules and data structures, e.g., an ML model that is configured to perform one or more tasks that the model was trained to perform. In some embodiments, one or more ML models may be trained to perform certain tasks described herein.

As used throughout the present disclosure, the term “machine vision” refers to a discipline of computer technology that includes the development of systems that process and understand visual information. A machine vision system may utilize a combination of computer hardware and software to enable the system to perceive visual data corresponding to the real world, and analyze, interpret, and perform actions based on visual information. Machine vision technology often may include the utilization of one or more imaging devices (e.g., camera), an analog-to-digital converter (ADC) and digital signal processing (DSP) to enable a machine to perceive a real-world environment in real time. Machine vision-based systems may leverage AI and one or more imaging devices to detect objects in the real world and perform actions in response to detected objects. The imaging device (e.g., camera) may be integrated with a processing unit (referred to collectively as a “smart camera”) or the imaging device may transmit data to process via a separate processing unit. Machine vision systems may be utilized in a variety of applications, including but not limited to, robotics, autonomous vehicles, quality control inspection, security, etc. As a nonlimiting example, computer vision utilized in autonomous vehicle technology may include the utilization of a camera system and/or a sensor system in combination with one or more object detection algorithms to analyze a surrounding environment in real time and recognize objects such as pedestrians, road signs, other vehicles, etc., to enable safe navigation of the a road.

As used throughout the present disclosure, the term “augmented reality” (or simply “AR”) refers to computer technology that integrates digital information with a user's physical environment in real time. AR technology enables a user to experience a real-world environment with generated perceptual information overlaid on top of the environment. AR may be used to visually change natural environments in some way, as well as to provide additional information to a user. A benefit of AR includes the ability to combine digital and three-dimensional (3D) components with an individual's perception of the real world. AR technology delivers visual elements, sound and/or other sensory information to a user through a display device. This information is overlaid onto the device to create an interwoven experience where digital information alters and/or enhances the user's perception of the real world. The overlaid information can be added to an environment or mask part of the natural environment. AR has a variety of applications, including providing additional information related to a surrounding environment, improved decision making within a surrounding environment, enhanced hazard detection, entertainment, as well as other applications. As a nonlimiting example, AR technology may be implemented into a vehicle to provide additional information to a driver and/or passenger regarding the surrounding environment of the vehicle.

As used throughout the present disclosure, the term “object” refers to both a living or non-living object existing in a surrounding environment. Examples of an object may include, but are not limited to, living organisms (e.g., humans, animals, etc.), non-living objects (e.g., balls, vehicles, broken glass, etc.), road features (e.g., potholes), as well as any other physical object. Further, an object inclusively may refer to a group of objects as well as a single object. For example, a group of children may be considered an object, as well as an individual child may likewise be considered an object. It is to be understood that the term object has no bearing on the living or non-living status of a particular thing. For example, an object may refer to a living being, as well as an inanimate thig, e.g., a rock. Further, it is to be understood that an object may likewise refer to a missing thing. For example, an object may refer to a hole in the ground of a roadway. While a hole technically does not comprise of physical matter, for the purposes of this disclosure, a hole is considered an object.

As used throughout the present disclosure, the term “environment context” refers to the features and/or circumstances that form the setting of the surrounding environment of a vehicle and/or object(s) existing in the surrounding environment. Further, the environment context includes all of the characteristics and/or attributes related to an environment in which a vehicle and/or object exists. Examples of environment context may include, but are not limited to, weather conditions (e.g., rain, snow, wind, etc.), road conditions, time of day, available light, etc. The environment context may be obtained by a sensor system configured to obtain environment context data from the surrounding environment.

As used throughout the present disclosure, the term “vehicle parameters” refers to a set of parameters associated with a particular vehicle. Examples of vehicle parameters may include, but are not limited to, vehicle speed, vehicle size, vehicle weight, vehicle stopping distance, vehicle stopping time, etc. It is contemplated herein that some vehicle parameters may be adjusted based on the particular environment context. As a nonlimiting example, the stopping distance and/or stopping time may differ when a road is wet due to rain, compared to a dry road.

As used throughout the present disclosure, the term “object behavior” refers to a plurality of possible actions associated with a particular object. As a nonlimiting example, if the object is a child, then the object behavior may include actions that may include, but are not limited to, running into the road, falling on the road, etc. As another nonlimiting example, if the object is an animal, then object behavior may include actions that may include, but are not limited to, walking into the road, running into traffic, laying down on the road, etc. Further, as used throughout the present disclosure the term “expected object behavior” refers to a particular object behavior (action) expected given a particular contextual scenario. The relationship between object behavior and expected object behavior may be understood as follows. Object behavior refers to all of the possible actions that may be associated with an object, while object behavior refers to particular possible action(s) based on the object, object behavior, and the contextual scenario. For example, suppose an object includes a child, the object behavior of the child includes all of the possible actions that can be taken by a child, and the expected object behavior may be the most likely action associated with the child, e.g., slipping and falling in the roadway because it is raining outside.

As used throughout the present disclosure, the terms “point of concern”, “POC”, “point of concern object” and “POC object” all refer to an object associated with predicted object behavior that may be indicative of a hazardous potential consequence to the vehicle, a driver, a passenger, the object, and/or the surrounding environment. It is contemplated that expected object behavior may not always correspond to a POC. As a nonlimiting example, a stationary inanimate object on the side of the road may be associated with object behavior that does not pose any threat to vehicle, the safety of the driver or passenger(s), the object itself, or the surrounding environment. Accordingly, in some embodiments described herein, animated media may be constructed for POC objects rather than for every object detected in a surrounding environment.

As used throughout the present disclosure, the term “media” refers to one more computer generated graphical elements. As a nonlimiting example, media may include animated media relating an object, wherein the animated media may include one or more graphical elements constructed and manipulated to provide the appearance of movement of the object. Further, media may include one or more graphical elements depicting a suggested alteration to a driving pattern. Further, media may include one or more graphical elements depicting one or more potential consequences resultant from a failure to adopt a suggested alteration to a driving pattern. Further, media may include one or more graphical elements depicting how much time and/or distance remains to adopt a suggested alteration to a driving pattern to prevent a potential consequence. Further, media may include one or more graphical elements depicting the severity associated with a point of concern object detected.

The illustrative embodiments provide for an augmented reality based object detection and behavior visualization system. Accordingly, illustrative embodiments include actively scanning a surrounding environment for one or more objects. Scanning a surrounding environment may include collecting data about a surrounding environment via a sensor system, and analyzing the sensor data to detect an object, a group of objects, and/or features and/or circumstances related to the surrounding environment.

Illustrative embodiments further include identifying a point of concern (POC) object from the one or more objects detected during scanning the surrounding environment. Identifying a POC object may be based in part on a combination of various factors and/or elements, including but not limited to, object properties, object behavior (including expected object behavior), environment context, vehicle parameters, and/or one more potential consequences resultant from a failure to adopt a suggested alteration in driving pattern of a vehicle. Further, in some embodiments, identifying a POC object may be based in part on consideration of vehicle speed, vehicle distance from an object, and a digital twin model of the vehicle. Further, in some embodiments, identifying a POC object considers historical information based at least in part vehicle speed, a digital twin model of the vehicle, road conditions, weather condition etc. Further, illustrative embodiments include a process recognizing objects, activities, and contextual scenarios in an environment, and determining that one or more objects may be a point of concern to a vehicle. Further, illustrated embodiments include a process that includes one or more historical learning algorithms to identify which objects in a surrounding environment may be a point of concern based on a current contextual scenario.

Illustrative embodiments include identifying a POC object based in part on potential consequences associated with the one or more objects detected. Further, illustrative embodiments include evaluating one or more potential consequences that may be associated with one or more objects detected in a surrounding environment. Potential consequences may be evaluated based in part on object properties, historical behavior corresponding to one or more objects, environment context, and/or vehicle parameters. The one or more potential consequences may include, but are not limited to, damage to the vehicle, injury caused to a driver and/or passenger, damage and/or injury caused to the object, and/or damage caused to the surrounding environment. Illustrative embodiments further include constructing a POC ranking based in part on the severity of consequence resultant from one or more POC objects identified. Illustrative embodiments further include a process that includes ranking the POC objects, wherein ranking the POC objects may be based in part on severity in driving, chances of injury, accidents, etc. Further, the process may construct a point of concern (POC) ranking based on the relative ranking of each point of concern object.

Illustrative embodiments further include suggesting an alteration to a driving pattern to prevent the occurrence of one or more potential consequences associated with one or more POC objects identified. Further, illustrative embodiments include evaluating an alteration to a driving pattern to prevent the occurrence of one or more potential consequences. Further, in some embodiments, evaluating an alteration to a driving pattern considers the vehicle distance from the POC object(s), and/or timing of the POC object(s) from the vehicle with respect to vehicle speed.

Illustrated embodiments further include generating media related to one or more objects detected and/or point of concern objects identified. Accordingly, in some embodiments, identified POC objects will be considered to create media content to display on an AR display interface of the vehicle. Illustrative embodiments include generating media depicting expected object behavior corresponding to a POC object identified. Illustrative embodiments further include generating media depicting a suggested alteration to a driving pattern to prevent one or more potential consequences associated with one or more identified POC objects. Illustrative embodiments further include generating media depicting one or more possible alterations automatically applied in the driving pattern upon identification of one or more POC objects, so that a passenger may be able to why the vehicle suddenly changed its driving pattern upon identification of a point of concern. Illustrative embodiments further include generating media depicting a safe distance from the one or more identified POC objects within which to perform an alteration to a driving pattern, so that the driver can take appropriate driving actions within a safe distance of the POC object. Illustrative embodiments further include generating media depicting one or more potential consequences that may result from a failure to adopt a suggestion alteration to a driving pattern of a vehicle. Accordingly, media depicting one or more potential consequences enables a driver of a vehicle to understand why the driving pattern of the vehicle should be altered to prevent the occurrence of one or more potential consequences.

Illustrative embodiments further include generating animated media corresponding to the POC ranking. Accordingly, the POC ranking based media corresponding to the POC ranking may be displayed in combination with other media representative of the POC(s) identified. Accordingly, generating and displaying additional media depicting the severity of the identified POC(s) may further enable a driver to take proactive action to alter the driver's driving pattern.

Illustrative embodiments further include displaying media corresponding to the one or more POC objects, one or more potential consequences associated with the one or more POC objects, and/or one or more suggested alterations to driving patterns to prevent the one or more consequences. Illustrative embodiments further include displaying animated media corresponding to the POC ranking. The animated media may include one or more graphical elements. Illustrative embodiments further include displaying the media described on a display interface. In some embodiments, the display interface includes an AR display interface. In some such embodiments, the AR interface is in the form of an AR glass interface incorporated into the windshield of a vehicle. In some embodiments, the AR interface is in the form of a monitor screen display device inside the cabin of the vehicle.

Illustrative embodiments include establishing an object behavior database based in part on historical object behavior data associated with one or more objects. Historical object behavior data may include object behavior data obtained from various sources. For example, object behavior data may be obtained from literature describing behavior of particular objects. As a nonlimiting example, object behavior associated with an animal may include all of the possible actions that may be performed by that animal. The historical object behavior data may also be obtained based on observed behavior of one or more objects. For example, if the object is a child, the object behavior data associated with the child may include all of the actions that have been observed performed by a child. In an embodiment, the object behavior database is continuously updated to include new behavior data corresponding to newly observed objects and/or newly discovered behavior relating to an object. Illustrative embodiments include constructing an object-behavior mapping between one or more objects and one or more object behaviors associated with the one or more objects. In some embodiments, the object-behavior mapping is stored on the object behavior database.

Illustrative embodiments include training an ML model to detect objects in a surrounding environment. Further, illustrative embodiments include training an ML model to predict expected object behavior based on historical object behavior. Predicting expected object behavior may also be based in part on environment context data. Accordingly, the behavior of an object may be influenced based on the environment context. Further, predicting expected object behavior may also be based in part on vehicle parameter data. Accordingly, the behavior of an object may be influenced based on the vehicle parameter data.

Accordingly, illustrative embodiments include a process that considers historical data related to the behavior associated with one or more objects to identify one or more point of concern objects, predicting an expected behavior based on the historical behavior data, suggesting an action to be taken based on the expected behavior, constructing an animated media depicting of one or more potential consequences resultant from a failure to adopt the suggest action, and displaying the animated media depicting the one or more potential consequences on an AR display interface.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

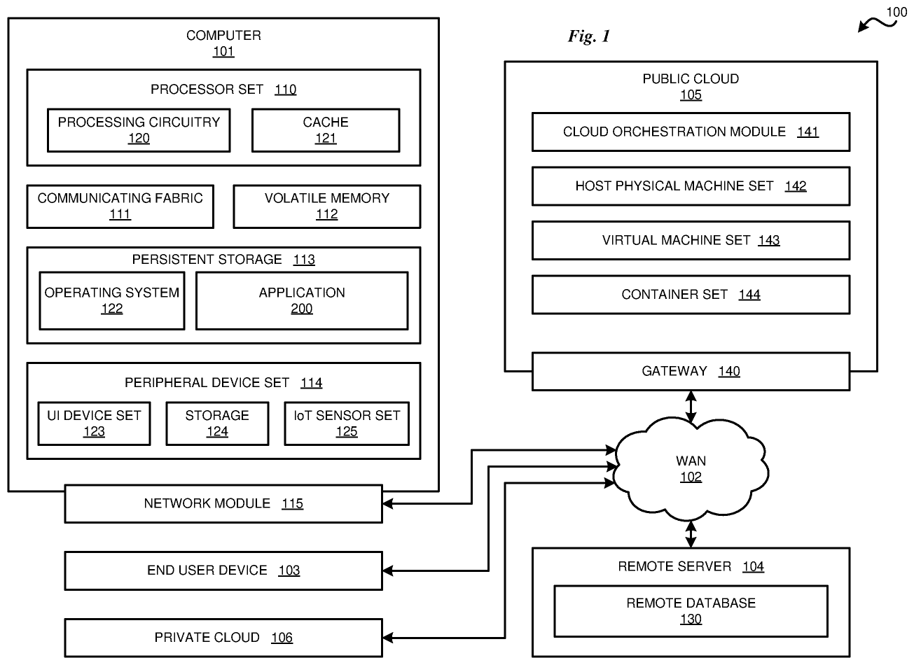

With reference to FIG. 1, this figure depicts a block diagram of a computing environment 100. Computing environment 100 contains an example of an environment for the execution of at least some of the computer code involved in performing the inventive methods, such as object detection module 200 that detects one or more objects in a surrounding environment and provides a visualization of one or more expected behaviors associated with the one or more objects detected. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

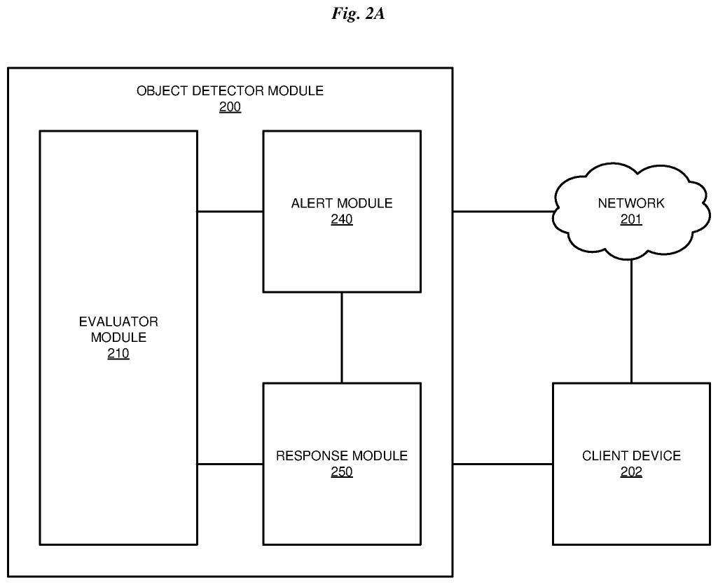

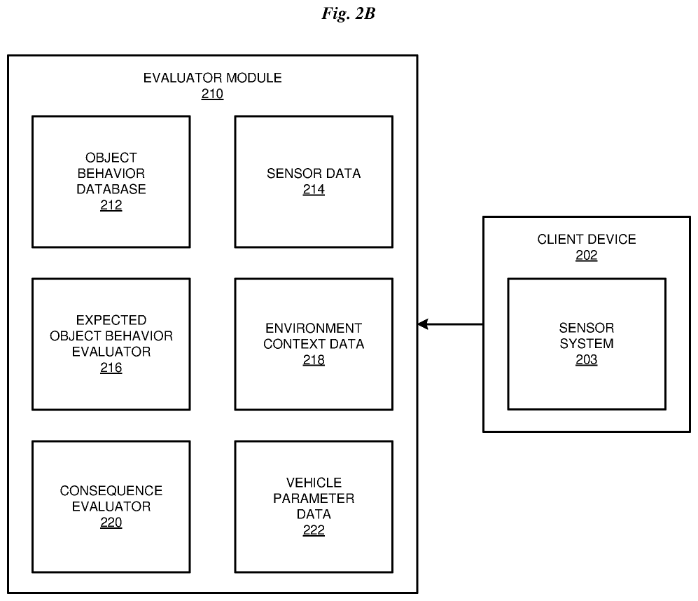

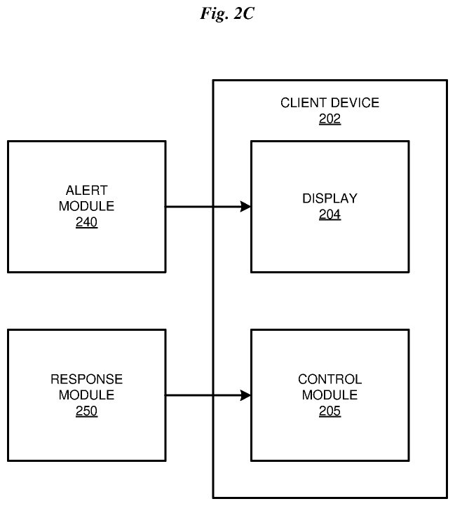

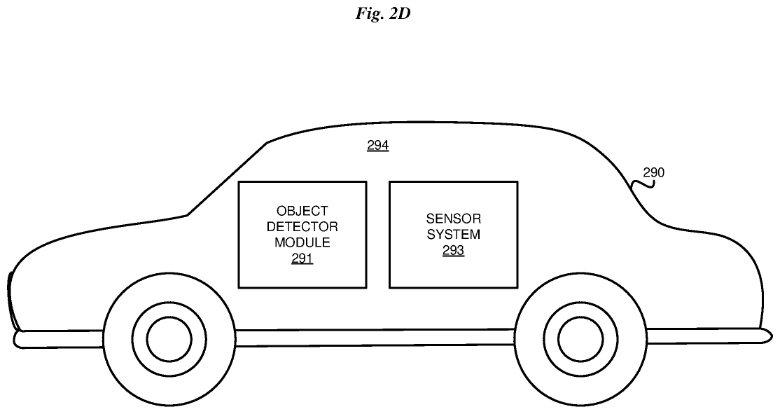

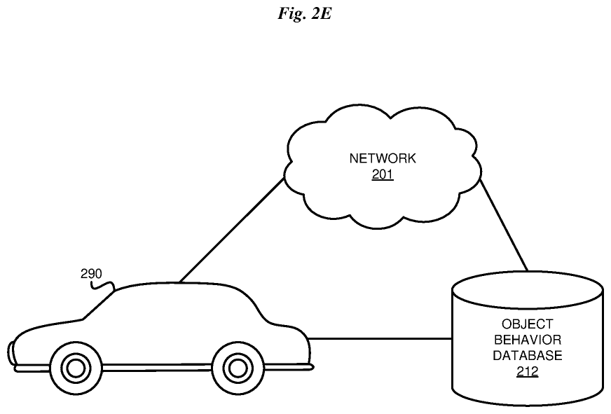

With reference to FIG. 2A, this figure depicts a block diagram of a computing infrastructure in accordance with an illustrative embodiment. In the illustrative embodiment, the object detection module 200 includes the object detection module 200 of FIG. 1.

In the illustrative embodiment, the object detection module 200 receives data from a client device 202 and/or a network 201. In an embodiment, the client device 202 is a computer system within a vehicle. Object detection module 200 may communicate to client device 202 and/or network 201 an API gateway. In some embodiments, client device 202 connects with the API gateway via any suitable network or combination of networks such as the Internet, etc. and uses any suitable communication protocols such as Wi-Fi, Bluetooth, etc. API gateway provides access to client applications like the object detection module 200. As a non-limiting example, in an embodiment, the client device 202 executes a routine to initiate interaction with the object detection module 200. For instance, in some embodiments, client device 202 executes a routine to instruct the object detection module 200 to identify one or more objects representing a point of concern in a surrounding environment, as described herein.

In the illustrative embodiment, object detection module 200 includes an evaluator module 210, an alert module 240, and a response module 250. The evaluator module 210 may be configured to evaluate expected object behavior based on an object detected, historical object behavior data, and an environment context, as described in greater herein. Further, upon evaluation of an expected object behavior, the evaluator module 210 may be configured to actuate alert module 240 and/or response module 250. In an embodiment, alert module 240 is configured to generate and transmit an alert, as described in greater detail herein. In an embodiment, response module 250 is configured to automatically perform a responsive action, as described in greater detail herein. In alternative embodiments, the object detection module 200 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

With reference to FIG. 2B, this figure depicts block diagram of an example evaluator module 210 in accordance with an illustrative embodiment. In the illustrative embodiment, evaluator module 210 is communicably coupled to a client device 202.

In the illustrative embodiment, evaluator module 210 includes an object behavior database 212 stored on a section of memory that stores historical object behavior data associated with one or more objects. Further, in the illustrative embodiment, evaluator module 210 includes sensor data storage 214 stored on a section of memory that receives sensor data from sensor system 203 of client device 202. In the illustrative embodiment, sensor system 203 includes one or more sensors configured to obtain data and transmit data to sensor data storage 214. In an embodiment, the sensor system 203 may include, but is not limited to, a visual sensor (e.g., camera(s)), a vehicle speed sensor (e.g., speedometer), a temperature sensor (e.g., thermometer), a humidity sensor, a rain sensor, a wind speed sensor, a vibration sensor, a proximity sensor, a position sensor, a motion detector, a photoelectric sensor, an infrared sensor, an ultrasonic sensor, a pressure sensor, an accelerometer, a gyroscope, a current sensor, voltage sensor, and/or any combination thereof. Further, the sensor system 203 may include a processor, a memory, and instructions stored on the memory that when actuated by the processor cause the sensor system 203 to obtain, process, and transmit sensor data to a plurality of locations, including the sensor data storage 214. In the illustrative embodiment, object detection module 200 of FIG. 2A detects an object based on sensor data obtained by the sensor system 203 and stored on sensor data storage 214. As a nonlimiting example, suppose sensor system 203 includes a camera, in which car sensor system 203 may record visual data of a surrounding environment and store said visual data on sensor data 214. Further, object detection module 210 may detect an object in a surrounding environment based on the visual data stored on sensor data storage 214 obtained from sensor system 203.

Further, in the illustrative embodiment, environment context data storage 218 stores environment context data related to a surrounding environment. Environment context data may be obtained by sensor system 203. Environment context data may include, but is not limited to, weather condition, road condition, etc. Further, in the illustrative embodiment, the vehicle parameter data storage 222 stores vehicle parameter data related to a vehicle. Vehicle parameter data may be obtained by sensor system 203. Vehicle parameter data may include, but is not limited to, vehicle speed, vehicle size, vehicle weight, vehicle stopping distance, vehicle stopping distance, vehicle stopping time, etc. Further, vehicle parameter data storage 222 may include a digital twin model corresponding to a vehicle, wherein the digital twin model may be constructed from corresponding vehicle parameter data.

In the illustrative embodiment, evaluator module 210 further includes an expected object behavior evaluator 216. The expected object behavior evaluator 216 may be configured to predict an expected object behavior based on a detected object, historical object behavior data associated with the detected object, and/or environment context data. Further, in the illustrative embodiment, the evaluator module 210 includes a consequence evaluator 220. The consequence evaluator 220 may be configured to evaluate one or more possible consequences associated with an object detected based on the object, expected object behavior, environment context data, and/or vehicle parameter data. For example, the consequence evaluator may evaluate damage caused to the vehicle upon collision with an object, damage caused to the object, damage caused to the surrounding environment, injury caused to a passenger of the vehicle, etc.

With reference to FIG. 2C, this figure depicts a block diagram of an example processing environment corresponding to a vehicle safety system. In the illustrative embodiment, client device 202 is shown coupled to alert module 240 and response module 250. In an embodiment, alert module 240 is configured to generate an animated media representation of expected object behavior on a display 204. In an embodiment, the display 204 is an AR display incorporated into the windshield of a vehicle. Accordingly, in such an embodiment, an animated media representation may be overlaid over the real world visible outside of the windshield in real time, to simulate the possible expected behavior of the object in real time. Further, the animated media may include one or more possible consequences associated with the detected object. Further, the animated media may include one or more suggested alterations to a driving pattern to prevent the occurrence of a possible consequence.

Further, in the illustrative embodiment, control module 205 is shown communicatively coupled to response module 250. In an embodiment, upon a determination to perform a response based on expected object behavior, the control module 205 performs an automatic response. In an embodiment, the automatic response includes an automatic vehicle response, including but not limited to, actuating the vehicle breaks, reducing the vehicle speed, steering the vehicle away from an object, etc. Accordingly, control module 205 may be communicably coupled to various systems within a vehicle, including a vehicle control system.

In an embodiment, the object detection module 200 ranks each of the POC objects detected, and constructs a POC object ranking based on the relative ranking of each POC object. In an embodiment, the POC ranking is based on the severity of consequences associated with detected POC. Further, in an embodiment, the object detection module generates one or more graphical elements to visualize POC ranking corresponding to the POC object(s) detected.

With reference to FIG. 2D, this figure depicts a diagram of an example vehicle equipped with an object detection module. Object detection module 291 includes an example of object detection module 200 of FIGS. 1 and 2A. Sensor system 293 includes an example embodiment of sensor system 203 of FIG. 2B. AR windshield display 294 includes an example embodiment of display 204 of FIG. 2C. Vehicle 290 includes an example embodiment of a client device 202 of FIGS. 2A-2C. As shown in the illustrative embodiment, the vehicle 290 is equipped with a sensor system 293 configured to obtain sensor data of a surrounding environment outside of the vehicle 290 as well as vehicle parameter data corresponding to the vehicle 290. Further, object detection module 291 is configured to detect one or more objects based on the sensor data obtained by the sensor system 293, analyze the sensor data to identify one or more point of concern (POC) objects, generate media relating to the one or more POC objects, and display the media on the AR windshield display 294 of the vehicle.

With reference to FIG. 2E, this figure depicts a diagram of an example vehicle communicatively coupled to an object behavior database. In the illustrated embodiment, the vehicle 290 is shown communicatively coupled to an object behavior database 212 and a network 201. In some embodiments, the object behavior database 212 is stored locally on a memory within the vehicle 290. In some other embodiments, the object behavior database 212 is stored off-site and may communicate data between the vehicle 290 via network 201. Accordingly, the vehicle 290 may identify one or more POC objects based on predicting expected object behavior of the one ore more objects, wherein predicting expected object behavior may includes assessing the object considering historical behavior corresponding to the object. In some embodiments, the functionality of features and/or elements described with reference to FIGS. 2A-2E as described herein is distributed among a plurality of systems, which can include combinations of software and/or hardware-based systems, for example Application-Specific Integrated Circuits (ASICs), computer programs, or smart phone applications.

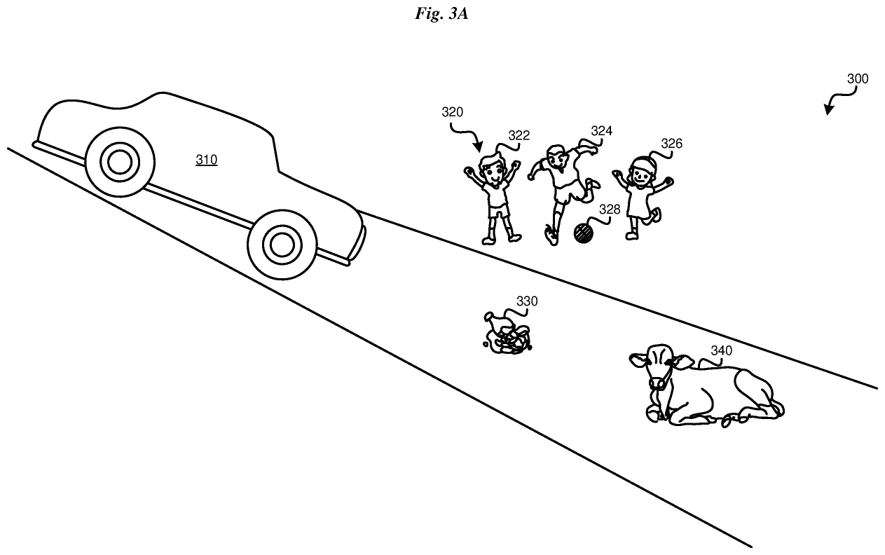

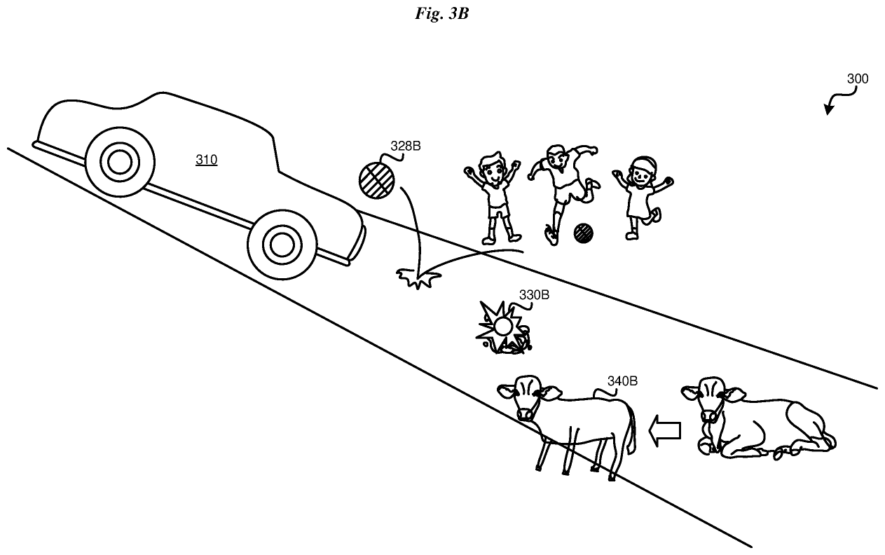

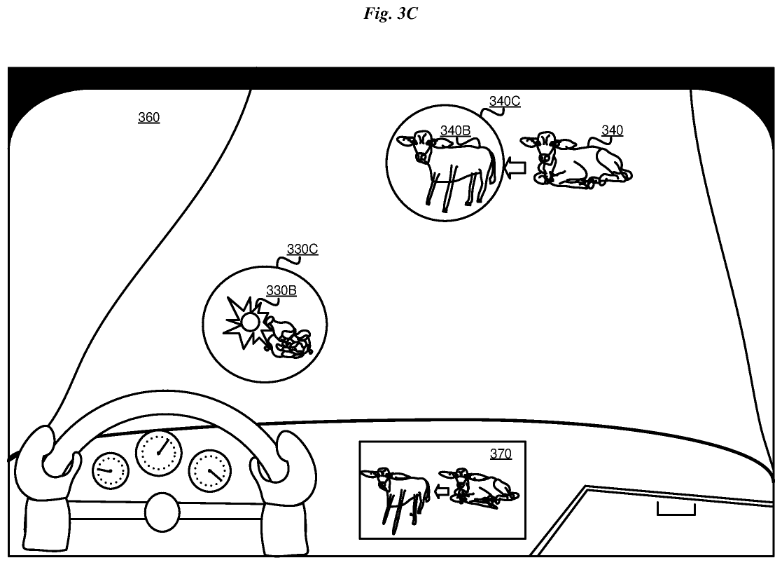

With reference to FIG. 3A, this figure depicts an example operating environment in accordance with an illustrative embodiment. In the illustrative embodiment, a vehicle 310 is shown driving along a road with numerous objects on or adjacent to the road. In an embodiment, vehicle 310 includes an example embodiment of vehicle 290 of FIGS. 2D-2E. In an embodiment, the vehicle 310 includes object detection module 200 of FIG. 1 and FIG. 2A. Accordingly, in an embodiment, the vehicle 310 may be equipped to functionally perform any or all of the operations of depicted by FIG. 1 and FIGS. 2A-2E.

In the illustrative embodiment, the vehicle 310 is configured to scan the surrounding environment 300 outside of the vehicle 310. In some embodiment, the vehicle includes a sensor system configured to obtain and process data corresponding to the surrounding environment 300. In some such embodiments, the sensor system includes an imaging device (e.g., a camera) configured to obtain and process visual data from the surrounding environment 300. Upon scanning the surrounding environment 300, the vehicle 310 may detect the presence of numerous objects within the surrounding environment. As depicted, the surrounding environment is shown including a group of children 320 including a first child 322, a second child 324, and a third child 326 playing with a ball 328. Further, the surrounding environment 300 includes shattered glass 330 in the road. Further, the surrounding environment includes an animal 340 laying in the road. Upon scanning the surrounding environment, the vehicle 310 may detect the presence of each of the objects mentioned. In an embodiment, the vehicle 310 may receive information related to the surrounding environment 300 that may not be immediately detectable by the vehicle 310 at a present moment in time. For example, it may be the case that a second vehicle (not shown) 10 kilometers away detects a hole in the road. Although the present vehicle 310 may not yet be in the immediate vicinity of the hole in the road, the present vehicle 310 may receive information regarding the upcoming hole in the road that was detected by the second vehicle.

With reference to FIG. 3B, this figure depicts an example operating environment in accordance with an illustrative embodiment. In the illustrative embodiment, the vehicle 310 predicts expected object behavior associated with each object that was detected. In the illustrative embodiment, the expected object behavior 328B associated with the ball 328 may include the action of the ball 328 bouncing into the road. Further, in the illustrative embodiment, the expected object behavior 330B associated with the shattered glass 330 may include the action of the shattered glass 330 puncturing a tire of the vehicle 310. Further, in the illustrative embodiment, the expected object behavior 340B associated with the animal 340 may include the action of the animal 340 standing up and walking in along the road.

With reference to FIG. 3C, this figure depicts an interior cabin view of the vehicle. In the illustrative embodiment, the vehicle 310 is shown equipped with an AR glass display 360 incorporated into the windshield of the vehicle 310. Further, in the illustrative embodiment, the vehicle 310 is shown equipped with a monitor screen 370. In the illustrative embodiment, a driver of the vehicle is able to see through the AR glass display 360 windshield of the vehicle to see the road ahead. As shown, there is an animal 340 laying down in the road as well as shattered glass 330 in the road. Upon detection of the animal 340 and the shattered glass 330, the vehicle 310 predicts expected behavior 340B and expected behavior 330B, and generates and displays an animated media representative of object behavior 340B and object behavior 330B on the AR glass display 360. Accordingly, the animated media representative of expected object behavior 330B and expected object behavior 340B is superimposed over the real surrounding environment seen by the driver, thereby alerting the driver that the shattered glass 330 may damage the vehicle's tire and/or that the animal 340 may stand up and walk across the road. Further, in the illustrative embodiment, media associated with the severity of a potential consequence associated with each object is shown. Accordingly, as a nonlimiting example, graphical element 340C may represent a higher severity of a potential consequence based on the expected object behavior 340B in comparison with the graphical element 330C representing a lesser severity of potential consequence based on the expected object behavior 330B.

In the illustrative embodiment, the animated media representative of the expected object behavior associated with an object is also displayed on the monitor screen 370 inside the cabin. For the sake of simplicity, not all of the objects depicted in FIGS. 3A and 3B are shown in FIG. 3C, although it is considered that the objects and corresponding expected object behaviors may likewise be displayed on the AR glass windshield display 360 and/or the cabin monitor screen 370. Further, for the sake of simplicity, not all of the possible generated media is shown displayed on the AR glass windshield display 360. Additional media that may be generated and displayed on the AR glass windshield display 360 may include, but is not limited to, a suggested alteration to driving pattern, a safe distance to perform a suggested alteration to a driving pattern, etc. A safe distance to perform a suggested alteration to a driving pattern may include any distance between the vehicle 310 and one or more POC objects sufficient to perform an alteration to a driving pattern. The exact safe distance may be dependent on the situation, and may be calculated at least in part based on factors that may include, but are not limited to, the speed of the vehicle, the object, the road condition, the weather, the contextual scenario, etc. It is contemplated that a safe distance in certain scenarios may be 1,000 ft, while a in other scenarios 500 ft or less may likewise be sufficient to perform an alternation to a driving pattern. For example, a safe distance to brake may be different in a situation where it is raining compared to a situation where it is not raining.

Further, although the vehicle 310 is depicted as a passenger vehicle in FIGS. 3A, 3B, and 3C, the use of this example is non-limiting, and the vehicle 310 may likewise include a commercial vehicle (e.g., truck), an aquatic vehicle (e.g., boat), a farm vehicle (e.g., tractor) a motorcycle, a non-motorized vehicle, (e.g., bicycle), and any other vehicle. Further, although the AR display is depicted as incorporated into the windshield of a vehicle, it is contemplated that the AR display may likewise include other forms, including but not limited to, an AR display incorporated into a visor of a helmet, an AR display incorporated into the lenses of a pair of glasses, an AR display incorporated in a headset, etc. Further, although the monitor screen 370 is depicted as monitor screen inside of the vehicle, it is contemplated that the monitor screen may likewise include other forms, including but not limited to, a desktop computer monitor screen, a handheld monitor screen, a laptop screen, a tablet, a smartphone screen, etc.

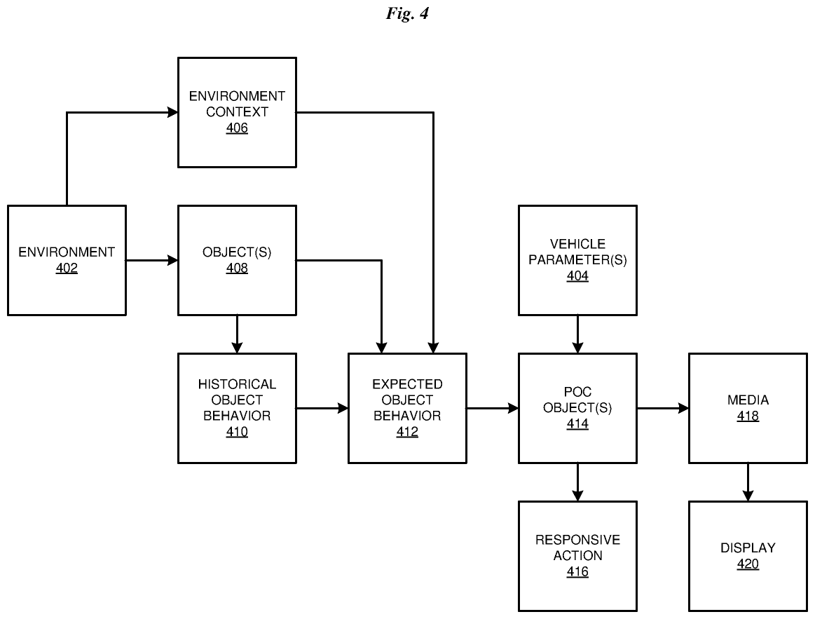

With reference to FIG. 4, this figure depicts a block diagram of an abstracted model of an example system for object detection and behavior visualization in accordance with an illustrative embodiment. In an embodiment, object detection module 200 of FIG. 1 and FIG. 2A is configured to perform some or all of the functions of system of FIG. 4.

In the illustrative embodiment, the system receives visual data corresponding to a surrounding environment 402 via one or more sensor systems configured to obtain visual data. In some embodiments, the sensor system includes one or more cameras configured to obtain visual data from the surrounding environment 402. In some embodiments, the sensor system includes an omnidirectional camera system configured to obtain visual data corresponding to 360 degree view of the horizontal plane of the surrounding environment 402. Further, based in part on the data obtained from the environment 402, the system detects an object 408 within environment 402. Nonlimiting examples of an object may include, but are not limited to, a group of kids playing near the road, an animal laying in the road, shattered glass existing in the road, a hole in the road, etc. In an embodiment, the one or more object(s) 408 are detected in the environment 402 using a machine learning model trained to detect objects, as described in greater detail herein the present disclosure. Further, based at least in part on the data obtained from the environment 402, the system constructs an environment context 406. As a nonlimiting example, the environment context 406 may include a weather conditions, road conditions, etc. Further, based on a combination of the object 408 that was detected in the environment 402, the environment context 406, and historical object behavior 410, the system predicts an expected object behavior 412 associated with the object 408. To continue on a previous nonlimiting example, suppose the objects 408 include a group of children playing with a ball near the road, the historical object behavior 410 associated with the ball and the group of children may include the actions of the ball going into the road, as well as a child chasing after the ball that has gone into the road, and the environment context may include a weather condition of rain. In such a depicted scenario, the expected object behavior 412 may include a child chasing after the ball into the road as well as slipping and falling in the road due to the road being slippery from being wet from the rain. Further, based on the expected object behavior 412 of the object(s) 408, and vehicle parameter(s) 404, the system may identify one or more POC object(s) 414 from the object(s) 408 identified. Further, based on POC objects (414) identified and the expected object behavior 412, the system may generate media corresponding to the expected object behavior 412. Further, the animated media may include a visualization of potential consequences if the driver and/or vehicle does not adjust driving pattern. To continue on the previous nonlimiting example, suppose the expected object behavior 412 includes a child chasing after a ball and falling in the road, the media 418 generated may be an animation that includes a child chasing after a ball and falling in the road.

Further, in the illustrative embodiment, the system may display the media 418 generated representative of the POC object(s) 414 on a display interface 420. In some embodiments, the display 420 is an augmented reality display. In some such embodiments, the augmented reality display is incorporated into the windshield of vehicle. Accordingly, in an embodiment where the media 418 is animated media displayed on an augmented reality display 420 on a windshield of a vehicle, the system enables driver of the vehicle to see a visualization of a child running into the road and falling, thereby alerting the driver to drive with caution when the driver is approaching and/or driving past the group of children playing near the road. In some embodiments, the display 420 is a monitor screen display located within the cabin of a vehicle. Accordingly, displaying the media 418 on a monitor screen display located within the cabin of a vehicle enables a passenger of a vehicle to see a visualization of the media 418 depicting the expected object behavior 412 of the one or more identified POC objects 414.

Further, in the illustrative embodiment, the system may perform a responsive action 416 based on the POC object(s) 414 detected. In some embodiments, the responsive action includes automatically actuating a vehicle response, including but not limited to, breaking, reducing the speed of the vehicle, steering the vehicle away from the object(s) 408, etc. In some embodiments, the responsive action 416 may include generating an alert and/or sending the alert to a driver and/or passenger of the vehicle. As a nonlimiting example, the alert may include playing a sound and/or audio recording to indicate the existence of POC object(s) 414. As another nonlimiting example, the alert may also include actuating a lighting system associated with the vehicle, including but not limited to, actuating the interior cabin lights of the vehicle to indicate the driver and/or passenger of the presence of one or more possible POC object(s) 414, actuating the rear brake lights to indicate to other vehicles of the presence of one or more possible POC object(s) 414, and/or actuating the headlights of the vehicle to indicate to the object 408 of the presence of the vehicle on the road. As another nonlimiting example, a responsive action may include generating a tactile alert, such as, for example, causing the driver seat and/or a passenger seat to vibrate to indicate the presence of a one or more possible POC object(s) 414.

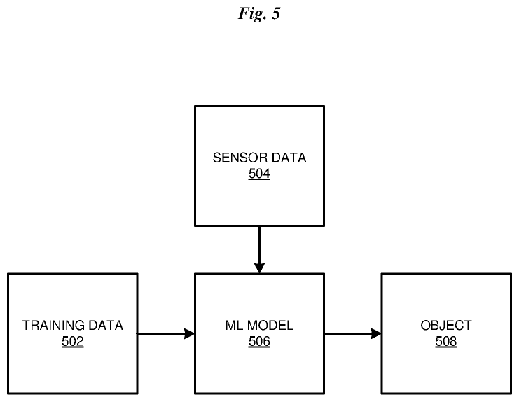

With reference to FIG. 5, this figure depicts block diagram of an abstracted model of processing environment for training a machine learning model to identify an object in a surrounding environment. In the illustrative embodiment, a machine learning (ML) model 506 is trained on a training dataset 502. In an embodiment, the training dataset 502 includes a image data corresponding to numerous objects. As a nonlimiting example, the ML model 506 may be trained on training dataset 502 that includes a dataset of images, wherein each image of the training dataset is labeled as an image of a pedestrian, an animal, an inanimate object, etc. Further, the ML model 506 may extract features from each labeled image to determine a particular set of features that correspond to a particular category (label). Further, the ML model may receive and process an unlabeled image, extract features from the unlabeled image, and classify the unlabeled data based on a comparison between features extracted from the unlabeled image to features extracted from labeled image. As a nonlimiting example, suppose a labeled image includes an image of a duck, in which case the ML model 506 may extract features including feathers, a beak, webbed feet, etc. Further, the ML model 506 may be input an unlabeled image, and extract features from the image that include feathers, a beak, and webbed feet, in which case the ML model 506 may compare the features of the unlabeled image to the features of the labeled image and accordingly may classify the unlabeled image as a duck, based on the similarity of features between the unlabeled image and the labeled image. Once the ML model 506 has been successfully trained on a training dataset 502, previously unseen data may be input to the ML model 506 and may be classified. In the illustrative embodiment, the ML model 506 receives sensor data 504 corresponding to data obtained via a sensor system. In an embodiment, the sensor system is a camera, and the sensor data includes visual data obtained by the camera corresponding to a surrounding. Accordingly, based on the features extracts from the sensor data 504, the ML model 506 may recognize an object 508 in the sensor data 504 obtained by a sensor system. Although the ML model 506 has been described with reference to recognizing objects in image data, it is contemplated that the ML model 506 may be trained to recognize objects based on any input data, such as audio data as well. In an embodiment, ML model 506 includes a convolutional neural network (CNN). Although a CNN is mentioned, the use of this example is non-limiting, and the ML model may incorporate other suitable neural network architectures utilized to recognize an object.

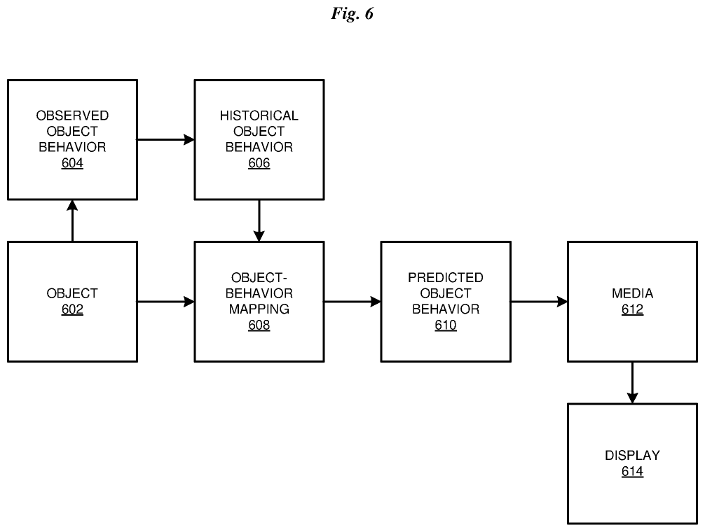

With reference to FIG. 6, this figure depicts an abstracted model of an example process of constructing an object-behavior mapping in accordance with an illustrative embodiment. In the illustrative embodiment, the process constructs database for storing historical object behavior data 604 based in part on previously observed object behavior 610. Accordingly, each time an object 602 exhibits some observed object behavior 610 related to the behavior of that particular object, the observed object behavior is stored as historical object behavior data 606 on a historical object behavior database. Further, the illustrated process associates particular historical object behavior data 606 with a particular object 602 to construct an object-behavior mapping 608 describing the relationship between the particular object 602 and the historical object behavior data 606. Further, when the process detects an object 602, the object 602 is compared against the object-behavior mapping 608 to obtain predicted object behavior 606 based on historical object behavior 606 associated with the object 602. Accordingly, each time an object 602 exhibits a new behavior, the object-behavior mapping 608 is updated based on updated historical object behavior 606. Further, repeated observed object behavior may indicate a greater likelihood that an object may exhibit a certain type of behavior. Accordingly, the predicted object behavior 610 may be based in part on the most likely behavior that an object may exhibit. In the illustrated embodiment, the predicted object behavior may be used in part to generate media 612 to representative of a visualization of predicted object behavior to display on a display interface 614, e.g., AR glass. In an embodiment, the historical object behavior database may include historical object behavior 606 obtained from external sources. For example, historical object behavior 606 may likewise include object behavior obtained from a separate database that includes behavior associated with particular objects. As another example, historical object behavior 606 may likewise include object behavior obtained from literary sources, including but not limited to, literature, publications, scientific papers, encyclopedias, etc.

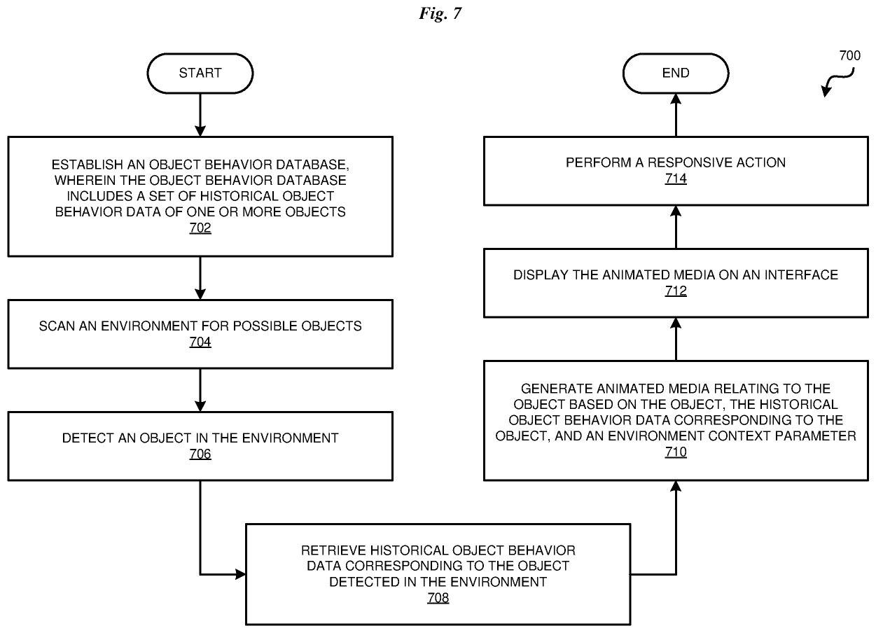

With reference to FIG. 7, this figure depicts a flowchart of an example process 700 for object detection and behavior visualization in accordance with an illustrative embodiment. In a particular embodiment, the object detection module 200 of FIG. 2A carries out the process 700.

In the illustrated embodiment, at block 702, the process establishes an object behavior database. In an embodiment, the object behavior database includes a set of historical object behavior data associated with one or more objects. The historical object behavior data may include object behavior data obtained from various sources. Accordingly, the historical object behavior database may include observed behavior corresponding to one or more detected objects. Further, the historical object behavior database may include historical object behavior from external sources. For example, historical object behavior 606 may likewise include object behavior obtained from a separate database that includes behavior associated with particular objects. As another example, historical object behavior may likewise include object behavior obtained from literary sources, including but not limited to, literature, publications, scientific papers, encyclopedias, etc.

At block 704, the process scans a surrounding environment for possible objects. Accordingly, the process may actively scan a surrounding environment for one or more objects by collecting data about a surrounding environment via a sensor system, and analyzing the sensor data to detect an object, a group of objects, and/or features and/or circumstances related to the surrounding environment. In some embodiments, the process utilizes a camera system disposed on the vehicle to obtain visual data of the surrounding environment.

At block 706, the process detects an object in the surrounding environment. In some embodiments, the process detects an object in the surrounding environment based on the visual data obtained by the camera system. Further, in some such embodiments, the process includes inputting the visual data into a machine learning model (ML) trained to detect objects within visual data. At block 708, the process retrieves historical object data corresponding to the object detected in the surrounding environment from the object behavior database. Accordingly, the process may compare a detected object to an object-behavior mapping to determine the behavior associated with the object that was detected.

At block 710, the process generates animated media relating to the object based on the object, the historical object behavior data of the object, and environment context data. Further, the environment context data be based in part on environment data obtained via a sensor system from a surrounding environment. In an embodiment, the process determines a contextual scenario based on visual data obtained via the camera system. In some other embodiments, the process determines a contextual scenario based on data from an external data source. As a nonlimiting example, the contextual scenario may include a weather condition, e.g., rain. Accordingly, the process may determine that it is raining based on the visual data obtained via the camera system, and/or based on weather data obtained from an external weather tracking source. As a nonlimiting example, the animated media may include animated media depicting a person walking into the road and slipping and falling on the road due to the wetness of the road caused by the rain.

At block 712, the process displays the animated media on a display interface. In an embodiment, the display interface includes an AR display. In some such embodiments, the AR display may be integrated into the windshield of a vehicle. In some embodiments, the display interface includes a monitor screen within a cabin of a vehicle. In some embodiments, the AR display is integrated into a wind visor of a helmet. In some embodiments, the AR display is integrated into the lenses of a pair of glasses. In some embodiments, the display interface includes a display interface existing in a remote location, e.g., a computer screen in a remote location outside of a vehicle. While the process describes the displaying animated media with reference to components of a vehicle, it is contemplated that the animated media may be displayed on any suitable display interface, related or unrelated to a vehicle, such as a smartphone of a passenger.

At block 714, the process performs a responsive action. Accordingly, the responsive action may be based on the object detected, the historical behavior of the object, and/or the contextual scenario. In some embodiments, the responsive action includes automatically actuating a vehicle action, including but not limited to, breaking, reducing the vehicle speed, steering the vehicle away from the object, etc. In some embodiments, the responsive action includes generating and providing an alert. In some such embodiments, the alert may include actuating a lighting system of a vehicle (e.g., interior cabin lights, break lights, headlights). In some such embodiments, the alert may include playing a sound and/or audio recording indicating existence of an object. In some embodiments, generating and providing an alert may include a tactile alert, such as for example, causing a seat in a vehicle to vibrate.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing an object behavior database, wherein the object behavior database comprises a set of historical object behavior data corresponding to one or more objects;
scanning a surrounding environment for one or more objects;
detecting an object in the surrounding environment;
retrieving a subset of historical object behavior data corresponding to the object detected in the surrounding environment;
generating media corresponding to the object based in part on the subset of historical object behavior data and a current contextual scenario; and
displaying the media on a display interface.

2. The computer-implemented method of claim 1, wherein generating media corresponding to the object further comprises generating media depicting expected behavior associated with the object.

3. The computer-implemented method of claim 1, wherein generating media corresponding to the object further comprises generating media depicting a potential consequence associated with the object.

4. The computer-implemented method of claim 1, wherein generating media corresponding to the object further comprises generating media depicting a suggested alteration to a driving pattern to prevent a potential consequence associated with the object.

5. The computer-implemented method of claim 1, wherein generating media corresponding to the object further comprises generating media depicting a safe distance to perform an alteration to a driving pattern to prevent a potential consequence associated with the object.

6. The computer-implemented method of claim 1, further comprising performing a responsive action based on the object, the subset of object behavior data, and the current contextual scenario.

7. The computer-implemented method of claim 6, wherein the responsive action comprises reducing vehicle speed.

8. The computer-implemented method of claim 6, wherein the responsive action comprises breaking.

9. The computer-implemented method of claim 1, wherein the display interface is an augmented reality interface, and wherein displaying the media on the augmented reality interface comprises superimposing the media over a real view of the surrounding environment in real time.

10. A computer program product for object detection and behavior visualization comprising one or more computer readable storage media, and program instructions collectively stored on the one or more computer readable storage media, the program instructions executable by a processor to cause the processor to perform operations comprising:
establishing an object behavior database, wherein the object behavior database comprises a set of historical object behavior data corresponding to one or more objects;
scanning a surrounding environment for one or more objects;
detecting an object in the surrounding environment;
retrieving a subset of historical object behavior data corresponding to the object detected in the surrounding environment;
generating media corresponding to the object based in part on the subset historical object behavior data and a current contextual scenario; and
displaying the media on a display interface.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, wherein generating media corresponding to the object further comprises generating media depicting expected behavior associated with the object.

14. The computer program product of claim 10, wherein generating media corresponding to the object further comprises generating media depicting a potential consequence associated with the object.

15. The computer program product of claim 10, wherein generating media corresponding to the object further comprises generating media depicting a suggested alteration to a driving pattern to prevent a potential consequence associated with the object.

16. The computer program product of claim 10, wherein generating media corresponding to the object further comprises generating media depicting a safe distance to perform an alteration to a driving pattern to prevent a potential consequence associated with the object.

17. A computer system comprising a processor and one or more computer readable storage media, and program instructions collectively stored on the one or more computer readable storage media, the program instructions executable by the processor to cause the processor to perform operations comprising:
establishing an object behavior database, wherein the object behavior database comprises a set of historical object behavior data corresponding to one or more objects;
scanning a surrounding environment for one or more objects;
detecting an object in the surrounding environment;
retrieving a subset of historical object behavior data corresponding to the object detected in the surrounding environment;
generating media corresponding to the object based in part on the subset of historical object behavior data and a current contextual scenario; and
displaying the media on a display interface.

18. The computer system of claim 17, wherein generating media corresponding to the object further comprises generating media depicting expected behavior associated with the object, generating media depicting a potential consequence associated with the object, and generating media depicting a suggested alteration to a driving pattern to prevent the potential consequence associated with the object.

19. The computer system of claim 17, wherein the display interface is an augmented reality interface, and wherein displaying the media on the augmented reality interface comprises superimposing the media over a real view of the surrounding environment in real time.

20. The computer system of claim 17, further comprising performing a responsive action based on the object, the subset of historical object behavior data, and the current contextual scenario.
